(19) United States
(12) Patent Application Publication
(10) Pub. No.: US 2025/0139474 A1
(43) Pub. Date: May 1, 2025

(54) MITIGATING BIAS IN MACHINE LEARNING WITHOUT POSITIVE OUTCOME RATE REGRESSIONS

(71) Applicant: Oracle International Corporation, Redwood Shores, CA (US)

(72) Inventors: Yasha Pushak, Vancouver (CA); Ehsan Soltan Aghai, Vancouver (CA); Hesam Fathi Moghadam, Sunnyvale, CA (US); Sungpack Hong, Palo Alto, CA (US); Hassan Chafi, San Mateo, CA (US)

(21) Appl. No.: 18/544,899

(22) Filed: Dec. 19, 2023

Related U.S. Application Data
(60) Provisional application No. 63/545,647, filed on Oct. 25, 2023.

(51) Int. Cl. G06N 7/01; G06N 5/04

(52) U.S. Cl. CPC G06N 7/01; G06N 5/04

(57) ABSTRACT

A computer obtains multipliers of a sensitive feature. From an input that contains a value of the feature, a probability of a class is inferred. Based on the value of the feature in the input, one of the multipliers of the feature is selected. The multiplier is specific to both of the feature and the value of the feature. The input is classified based on a multiplicative product of the probability of the class and the multiplier that is specific to both of the feature and the value of the feature. In an embodiment, a black-box tri-objective optimizer generates multipliers on a three-way Pareto frontier from which a user may interactively select a combination of multipliers that provides a best three-way tradeoff between fairness and accuracy. The optimizer has three objectives to respectively optimize three distinct validation metrics that may, for example, be accuracy, fairness, and favorable outcome rate decrease.

### BENEFIT CLAIM

This application claims the benefit under 35 U.S.C. § 119 (e) of provisional application 63/545,647, filed Oct. 25, 2023, by Yasha Pushak et al., the entire contents of which is hereby incorporated by reference. The applicant hereby rescinds any disclaimer of claim scope in the parent applications or the prosecution history thereof and advise the USPTO that the claims in this application may be broader than any claim in the parent application.

### FIELD OF THE INVENTION

The present invention relates to postprocessing calibration of class probabilities inferred by a machine learning (ML) model. Herein is a novel combination of three distinct optimization metrics, including two distinct fairness metrics, including one that minimizes harm.

### BACKGROUND

Machine learning (ML) models can often be used in applications where their decisions will directly impact people. In these sensitive applications, one must be careful so that the ML models' automated decisions do not disproportionately affect different subgroups of a population. For example, a selection tool should not systematically favor one kind of candidates. While methods have been proposed to mitigate unintended bias present in machine learning models, it remains challenging to train an ML model that satisfies high levels of fairness and accuracy at the same time.

Shortcomings in the state of the art include at least the following.
Use of random selection or random generation to generate or adjust an inference is nondeterministic, which means that an inference might not be repeatable, which may complicate an attempt to explain an inference.
Preprocessing of a training corpus or adjustment inside an ML model may require retraining the ML model, which is slow and may discourage exploration and comparison of solution variations.
Only binary classification between two classes may be supported.
An inferred probability or an inferred score may, by adjustment, become outside a supported range, which alters a classification boundary and will break any predefined threshold such as an anomaly detection threshold.
Lack of configurability may cause acceptance of a suboptimal generated solution, and a generated solution is fragile and may break if requirements or data evolve.

In the state of the art, fairness maximization may be oversimplified as a single objective. As discussed later herein, a single overall fairness metric may, for example, be based on all subgroups, including subgroups whose disproportionate effects offset (i.e. cancel out) each other, which may hide unfairness from, for example, an optimizer.

### BRIEF DESCRIPTION OF THE DRAWINGS

In the drawings:

FIG. 1 is a block diagram that depicts an example computer that calibrates probabilities, inferred by a trained classifier, based on postprocessing scaling of respective probabilities of mutually exclusive classes and based on one of multiple values of a sensitive feature;

FIG. 2 is a flow diagram that depicts an example computer process that classifies an input based on postprocessing calibration of inferred probabilities of respective classes;

FIG. 3 is a flow diagram that depicts an example computer process that uses a tri-objective optimizer to optimize multipliers respectively for values of a sensitive feature;

FIG. 4 is a block diagram that illustrates a computer system upon which an embodiment of the invention may be implemented;

FIG. 5 is a block diagram that illustrates a basic software system that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Here is postprocessing calibration of class probabilities inferred by a machine learning (ML) model. A tri-objective optimizer tunes a novel combination of three distinct validation metrics, including two distinct fairness metrics, including one that minimizes harm. Postprocessing scales respective probabilities of multiple classes based on an input value of a sensitive feature. Scaling uses a multiplier that is multi-objectively optimized to be an excellent three-way tradeoff between fairness and accuracy. This optimization fulfills the following three concerns for producing ML models that are fairer in industrial application settings.

One concern is enforcement of application-specific fairness. While methods have been proposed to mitigate unintended bias present in ML models, it remains challenging to train a ML model that satisfies high levels of fairness and accuracy at the same time. Herein is a more practical approach to producing fair models by discovering a set of models with different fairness-accuracy tradeoffs. This allows an end user to select the model that best matches their specific application's need for fairness and accuracy altogether.

Another concern is being fair and accurate for any metric. There are different ways to measure fairness and accuracy of a given model. Every application has different needs and therefore different relevant metrics to optimize for. The approach herein for increasing a model's fairness is flexible enough to allow any metric to be optimized for. It is possible to optimize any combination of fairness-accuracy metrics.

Another concern is making the model fairer without random assignment. The state of the art may increase a model's fairness by randomly flipping (e.g. reclassifying) some predictions in order to artificially increase or decrease an outcome rate for a protected group. This may be convenient because it simplifies the task of increasing a group's selection rate to picking the percentage of the group's individuals for which predictions should be reclassified to a different label. However, unpredictability of randomness is undesirable behavior in enterprise applications. The approach herein increases a group's selection rate by picking among its individuals that are most likely to have the desired label. For example, to increase the number of some kind of candidates selected in screening decisions, this approach selects the candidates that the ML model already identified as nearest to being selected, instead of randomly sampling from rejected candidates of that kind. Protected groups, sensitive features, and their interrelationship are discussed later herein.

This approach entails multiplier tuning for postprocessing that is straightforward to implement. This approach increases or decreases the majority class's predicted probability by multiplying by different magnitudes for every protected group. The intuition behind this effectively entails using a model's output confidence as a ranking of which individuals should be more likely to have their predicted label corrected. Increasing a protected group's selection rate with respect to a label may entail increasing all of the group's predicted probabilities, which increases the amount in the group that attain that label.

Rather than going through the difficult task of learning different multipliers for every label for each class, multiplier optimization may be accelerated by only requiring a multiplier for manipulating the predictions of the majority class, which is the label with the largest number of samples inside the dataset. This design decision of applying a multiplier to the majority class readily extends to multiclass classification, even though existing methods are limited to binary classification (i.e. not multiclass).

Multiplier tuning herein is a multi-objective optimization task that finds postprocessed variations of a model that maximize fairness while minimizing accuracy loss. To this end, there might be no single optimal solution, because some applications may require a perfect fairness criterion while others may find accompanying accuracy loss too prohibitive to reach perfect fairness. Herein, the solution concept for this multi-objective optimization problem is a Pareto frontier that consists of the best found three-way tradeoffs of objectives such as fairness and accuracy. Here, the best tradeoffs represent models that are not outperformed on both metrics by another model variation found. Intuitively, if model variation A was outperformed on both metrics by a model variation B, there is no reason whatsoever to prefer model A over model B. Therefore, model B may be a Pareto optimal model, but model A would not be. Multi-objective optimization is an inherently challenging endeavor. For straightforward implementation and complete versatility, a best of breed black-box multi-objective optimizer may be used as discussed later herein.

A tri-objective optimizer produces a better three-way Pareto frontier than a two-way Pareto frontier produced by a bi-objective optimizer. Diversity measures how many points are in a Pareto frontier and/or how much separation (i.e. spacing) is between those points. More diversity is quantitatively better, and the three-way Pareto frontier herein has increased diversity of points. Convergence measures the distance between the generated Pareto frontier and the known correct Pareto frontier. Less distance (i.e. more convergence) is quantitatively better, and the three-way Pareto frontier herein has increased convergence. Thus, convergence measures accuracy of the optimization itself. For convergence and diversity, the three-way Pareto frontier herein is a general improvement over a two-way Pareto frontier, and this improvement is quantitative and technologic.

However, the three-way Pareto frontier herein also is a special improvement for fairness. A two-way Pareto frontier effectively protects fewer protected groups (e.g. ethnicities) than does the three-way Pareto frontier. This novel three-way Pareto frontier is generated inside a computer and by, for example, increasing a count of effectively protected groups, the internal performance of the computer itself is quantitatively improved. The tri-objective optimizer may generate a sequence of validations, and each validation is a distinct maximization of both of ML model accuracy and ML model fairness. An optimization computer that uses this novel combination of three distinct quantitative objectives will generate a Pareto frontier from which a best postprocessing configuration may be selected to increase the fairness of machine learning inferences. Increased diversity, increased convergence, and effective protection of more protected groups are three quantitative technologic improvements of the optimization by the computer. Thus, the performance of the optimization computer itself is quantitatively improved.

This approach relies on evaluating numerous different model variations and computing their respective fairness and accuracy scores. For large datasets (100,000+ samples), most of the running time of this approach may be spent measuring scores. Randomly sampling from a large dataset to a smaller version that is faster to compute metrics on was experimentally proven to introduce negligible score error when compared to using the entire dataset. A random subsample of 50,000 individuals for datasets larger than that greatly accelerates optimization on massive datasets with no or almost no cost on score precision.

Another problem is what happens when a large number of protected groups (n>5) have to be considered for fairness. In this case, the multipliers' search space is n-dimensional, making the optimization problem much harder. Indeed, black-box optimization has to take into account interactions of the many groups together to optimize for fairness. To compensate, the number of total trials of the tuning algorithm is linearly scaled with the number of groups. This scaling has good performance on applications with a large number of groups and avoids exponential running time complexity.

This approach has at least the following innovations. This is the first fairness postprocessing method to provide all of: a) return a collection of models representing different fairness-accuracy tradeoffs, b) supports any fairness and accuracy metrics combination, and c) uses a novel combination of three distinct quantitative objectives to generate a Pareto frontier that has increased optimization accuracy. A protected group's selection rate is adjusted without using randomness. This method is readily applicable to multiclass classification. This method does not entail a threshold. Adjustment caused by applying one multiplier occurs for all of multiple classes.

This approach has at least the following advantages. It is straightforward to implement. It returns a collection of models for a user to pick from. This allows the user to have the final say in what is the fairness-accuracy tradeoff they prefer for their application. This approach is versatile and can be applied to any machine learning model for binary or multiclass classification to improve any given fairness and accuracy metrics combination. This approach is scalable and only requires a number of operations that is linear with respect to the number of protected groups present in the data. Furthermore, if a validation dataset is available, it does not require training any additional machine learning models because training and retraining is not part of this method.

This approach is deterministic at inference time. Unlike existing bias mitigation postprocessing procedures, this method will always return exactly the same prediction for a given test example, because it does not rely upon random sampling to alter the predictions. This approach returns interpretable probabilities. Other bias mitigation methods directly modify predictions without adjusting the prediction probabilities. This means that the original model prediction probabilities can no longer be interpreted normally. For example, a label that has a prediction probability of 0.99 may in fact not end up being the predicted label with other methods. This also means that any method of scoring the accuracy of a model that relies on prediction probabilities (e.g., log loss, AUC ROC) cannot be used with those methods but can be used herein.

This approach makes business-aligned decisions. That is, the predictions that are changed are those that were closest to having been different in the first place. In a hiring example application, this means that a completely unqualified candidate will not be selected for hiring if there exists a more qualified candidate in the same protected group. This is not true for existing bias mitigation postprocessing strategies. This approach can be paired with random sampling to accelerate optimization. Users with large datasets can realize large running time speedups with minimal loss in quality by extending this method with random sampling to decrease the size of the dataset, thereby substantially decreasing the cost of computing metrics. For example, the metric computation time was decreased from about 3 hours to about 5 minutes, with only a 2% metric estimation error.

In an embodiment, a computer obtains multipliers of a sensitive feature. From an input that contains a value of the feature, a probability of a class is inferred. Based on the value of the feature in the input, one of the multipliers of the feature is selected. The multiplier is specific to both of the feature and the value of the feature. The input is classified based on a multiplicative product of the probability of the class and the multiplier that is specific to both of the feature and the value of the feature. In an embodiment, a black-box tri-objective optimizer generates multipliers on a three-way Pareto frontier from which a user may interactively select a combination of multipliers that provides a best three-way tradeoff between fairness and accuracy. The optimizer has three objectives to respectively optimize three distinct validation metrics that may, for example, be accuracy, fairness, and favorable outcome rate decrease.

### 1.0 Example Computer

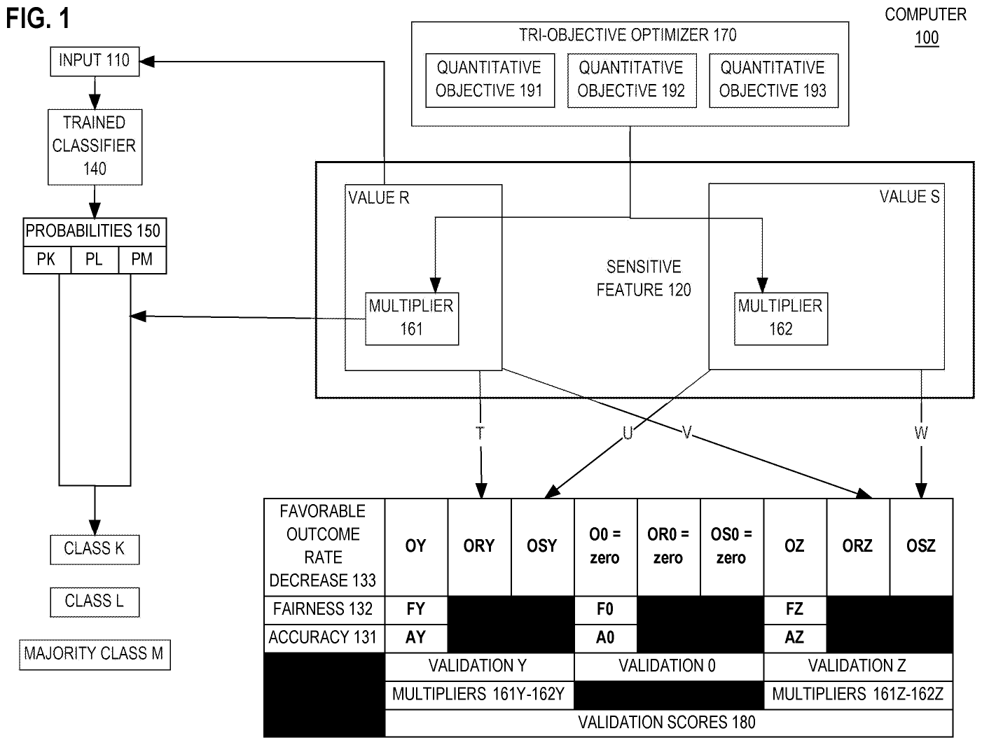

FIG. 1 is a block diagram that depicts an example computer 100, in an embodiment. Computer 100 may be one or more of a rack server such as a blade, a mainframe, a personal computer, or a virtual machine.

Computer 100 calibrates probabilities PK-PM inferred by trained classifier 140 that is a machine learning (ML) model. This calibration is postprocessing for scaling of respective probabilities of mutually exclusive classes K-M based on one of multiple values R-S of sensitive feature 120. Sensitive feature 120 deserves special consideration because it is positively or negatively correlated with a protected group of inputs. In an embodiment, input 110 is a feature vector, such as a one-dimensional array of numbers, that represents a record of a subject such as a person.

Input 110 has a respective value of each of multiple features, including sensitive feature 120. Each feature has a respective datatype such as a number, a string, or a data structure, and all of those datatypes can be numerically encoded in a feature vector such as by one-hot encoding or hash encoding. For example, input 110 has value R of sensitive feature 120, and other inputs (not shown) may have either of values R-S.

### 1.1 Machine Learning Classifier

In one example, trained classifier 140 is an opaque (i.e. black box) ML model that cannot be retrained by computer 100. For example, the user of computer 100 might not know how trained classifier 140 was trained. For example, the user might not know if trained classifier 140's training was supervised or unsupervised.

However, computer 100 is configured to validate trained classifier 140 using a validation corpus that contains input 110 and multiple other inputs. In an embodiment: validation is supervised; the validation corpus is labeled; and each of input has a respective label (not shown), which is a known correct classification (i.e. identification of one of classes K-M).

Trained classifier 140 accepts an input (e.g. 110), which causes trained classifier 140 to infer (i.e. generate) a learned inference that contains a respective probability for each of classes K-M. For example, trained classifier 140 infers probabilities 150 from input 110. Probabilities 150 contains probabilities PK, PL, and PM respectively for classes K-M.

For example for input 110, probability PM is inferred for majority class M. The state of the art may maximize accuracy by classifying input 110 as majority class M if probability PM is the highest in probabilities 150. Herein if probability PM is the highest in probabilities 150, novel multiplier 161 may cause input 110 to instead be classified as any of classes K-M as discussed below. Thus unlike the state of the art, computer 100 classifies input 110 not to strictly maximize accuracy, but instead to minimize a decrease of a favorable outcome rate and, in some scenarios, also maximize fairness and/or accuracy.

### 1.2 Probability Multipliers

As discussed later herein, computer 100 automatically discovers multiple optima that are respective different three-way tradeoffs between: 1) fairness, 2) accuracy, and 3) a decrease of a favorable outcome rate. Computer 100 can retroactively switch between different tradeoffs without retraining, revalidating, nor otherwise using trained classifier 140. For example, once validation scores 180 are generated as discussed later herein, any of many multipliers 161-162 of sensitive feature 120 may be retroactively applied to recalibrate any inferred probabilities (e.g. 150) without using trained classifier 140.

Thus architecturally, recalibration by applying multipliers 161-162 is postprocessing, which is downstream of trained classifier 140. It does not matter if postprocessing occurs immediately after inferring probabilities 150 or deferred until input 110 might need reclassification without using trained classifier 140. In other words, probabilities 150 may be live or archival. For example, retroactive postprocessing of probabilities 150 may occur even if trained classifier 140 was discarded.

Multiplier 161, for example, achieves recalibration of probabilities 150 as follows. Herein it does not matter if: a) majority class M is whichever class is most frequent in the labeled validation corpus that contains input 110 and other inputs, or b) majority class M is the class that most frequently has the highest probability in inferences by trained classifier 140.

In one example, probability PM may be the highest in probabilities 150 until probability PM is multiplied by multiplier 161 to generate a multiplicative product (not shown). Multiplier 161 is a positive real number that, if less than one, generates a multiplicative product that is less than probability PM. Likewise, multiplier 162 may or may not be greater than one, which generates a multiplicative product that is greater than probability PM. Because the multiplicative product is used during postprocessing herein as a replacement of the originally inferred probability (e.g. PM) of majority class M, the probability of majority class M relative to other classes K-L may be decreased or increased based on which one of multipliers 161-162 is used, which is dynamically selected as follows.

Herein, each of distinct values R-S of sensitive feature 120 or, in an embodiment not shown, each distinct disjoint (i.e. nonoverlapping) subset of values of sensitive feature 120, has a respective distinct multiplier. Herein, each distinct value or each distinct subset of values of sensitive feature 120 is referred to as a protected group. Herein, there always are multiple protected groups in sensitive feature 120 and thus multiple multipliers as discussed below. The value of sensitive feature 120 in an input determines which of multipliers 161-162 is selected for that input. For example, multiplier 161 is selected for input 110 that has value R for sensitive feature 120. Likewise, multiplier 162 is selected for other input(s) that instead have value S for sensitive feature 120.

For example, probability PM may be the highest in probabilities 150, and multiplier 161 may cause probability PM to become relatively lower than zero or more of other probabilities PK-PL. For example after applying multiplier 161 to probability PM, probability PK may become the highest. In that case, input 110 would be classified as class K even though probability PM was originally higher than probability PK.

In another example, trained classifier 140 infers probabilities from another input (not shown). That input has value S for sensitive feature 120, which means that multiplier 162 is selected for that input. The probability of class L may be the highest in the probabilities inferred from that input, and multiplier 162 may cause the probability of class M to become relatively higher than zero or more of probabilities of other classes K-L. For example after applying multiplier 162 to the probability of class M, that probability may become the highest. In that case, that input would be classified as class M even though the probability of class M was originally lower than probability of class K.

In those ways, a multiplier may more or less immediately cause a live classification to a class of a lower probability. Likewise in those ways after a previous classification of an input, a retroactively applied multiplier may subsequently cause a reclassification of the input to a class of a lower probability.

### 1.3 Multiplier Optimization

The lifecycle of multipliers 161-162 has an optimization phase followed by an application phase. As follows, optimized generation of multipliers 161-162 during the optimization phase may be based on optimization components 170 and 180 whose sole purpose is to optimize multipliers 161-162 after which those optimization components may be discarded along with the validation corpus, including input 110 and its inferred probabilities 150. In other words, deployment for the application phase might entail only production components 140, 161-162, and K-M.

In production, new inputs may occur that were not in the validation corpus and, for example, did not exist during the optimization phase, and trained classifier 140 may infer new probabilities for those new inputs as discussed later herein. During the optimization phase, all of the components shown in FIG. 1 are stored or generated in random access memory (RAM) in computer 100. The application phase may occur on a same or different computer in a same or different environment as the optimization phase.

The optimization phase has a sequence of validations 0 and Y-Z. The dark rectangle shown beneath baseline validation 0 indicates that validation 0 does not use multipliers 161-162. For each of validations Y-Z, tri-objective optimizer 170 generates a respective distinct pair of values for multipliers 161-162. For example, validation Y has multiplier values 161Y-162Y for respective multipliers 161-162.

Herein, a validation is defined by its distinct pair of values for multipliers 161-162, and validation scores 180 depend on these multipliers. That is, multipliers 161Y-162Y and 161Z-162Z are independent variables, and validation scores A0 and AY-AZ, F0 and FY-FZ, O0 and OY-OZ, OR0 and ORY-ORZ, and OS0 and OSY-OSZ are shown bold to indicate that they are dependent variables.

In an embodiment, a validation (i.e. its distinct plurality of multipliers as discussed above and later herein) is generated by computer 100 or by tri-objective optimizer 170. In an embodiment, tri-objective optimizer 170 generates every validation except validation 0 that lacks multipliers, which computer 100 generates with value one for all multipliers 161-162, which is logically the same as no multipliers. Each generated validation is evaluated by computer 100 to generate respective (e.g. three) validation scores. Herein, a plurality of multipliers of sensitive feature 120 may be referred to as a validation. For example, the pair of multipliers 161Y-162Y is validation Y.

In an embodiment, tri-objective optimizer 170 is a multi-objective optimizer into which any amount (e.g. three) of custom objectives may be loaded. In the shown embodiment, tri-objective optimizer 170 has: a) quantitative objectives 191-192 that maximize respective validation metrics 131-132 and b) quantitative objective 193 that minimizes validation metric 133.

### 1.5 Validation Measurements

Validation metrics 131-133 are distinct and independent of each other. As discussed later herein, validation metrics 132-133 may be somewhat conceptually overlapping because they measure fairness in different ways and, in some embodiments, validation metrics 132-133 may have partially overlapping implementations.

Supervised validation is based on the labels in the validation corpus as discussed earlier herein. Accuracy 131 is supervised. None, some, or all of fairness metrics 132-133 are supervised or self-supervised.

Validation scores 180 contains individual validation scores A0 and AY-AZ, F0 and FY-FZ, O0 and OY-OZ, OR0 and ORY-ORZ, and OS0 and OSY-OSZ that are shown bold and measured as follows. Herein, a validation has a separate validation score for each of validation metrics 131-133. For example, validation Y has validation scores AY, FY, and OY respectively for validation metrics 131-133.

Each of accuracy scores A0 and AY-AZ is measured during a respective one of validations 0 and Y-Z. Accuracy metric 131 may generally be any model fitness metric, which measures accuracy scores A0 and AY-AZ. For example, many distinct fitness metrics are based solely on a confusion matrix or not based on a confusion matrix.

During each of validations 0 and Y-Z, a respective one of fairness scores F0 and FY-FZ is measured. An embodiment may use any of the following classification fairness metrics as an underlying fairness metric to implement fairness 132: Statistical Parity Difference (SPD), Disparate Impact (DI), Equal Opportunity Difference (EOD), Equalized Odds Difference (EOD), Demographic Parity (DP), Conditional Demographic Disparity (CDD), Theil's Information Inequality, Confusion Matrix Disparity (CMD), Consistency Score, and Treatment Equality (TE). Fairness metrics 132-133 operate differently as follows.

Fairness measurements F0 and FY-FZ may be for a particular protected group (e.g. value R by itself or relative to value S that may or may not be a majority protected group) or may be for all protected groups overall and, in either case, the measurement directly applies a fairness metric to a single set of inferences that are generated during a single validation. All validations may share a same validation corpus (not shown) that contains many inputs, including input 110, and share trained classifier 140 without retraining.

The shown dark rectangle to the right of validation scores AZ and FZ demonstrates that, during validation Z, fairness 132 measures only one fairness score FZ, and accuracy 131 measures only one accuracy score AZ. Both of validation scores AZ and FZ are based on only one validation Z.

### 1.6 Favorable Outcome Rate

However during validation Z, favorable outcome rate decrease 133 measures three favorable outcome rate decreases OZ and ORZ-OSZ that are based on exactly two validations 0 and Z. In other words, favorable outcome rate decrease 133 compares one of validations Y-Z to validation 0.

One of classes K-M is a favorable outcome, which may be inferred for both of protected groups R-S, but at different rates (i.e. frequencies). For example, if class K is favorable and value S is, for example, a historically disadvantaged protected group, then class K may be more often inferred for value R than for value S, which may be more or less unfair.

Herein, baseline validation 0 does not use multipliers 161-162 and always occurs before validations Y-Z that use multipliers 161-162. As discussed earlier herein, multipliers 161-162 may flip some class inferences, which means that multipliers 161-162 may increase or decrease a favorable outcome rate for one, some, or all of protected groups R-S. A favorable outcome rate for a validation may be a percentage of inferences with favorable class K, for one protected group or for all protected groups.

Favorable outcome rate decrease 133 compares validation 0 to, for example, validation Y as follows. Favorable outcome rate decrease 133 is biphasic, which means that favorable outcome rate decreases ORY-OSY are measured before measuring overall favorable outcome rate decrease OY that may, for example, be an average of favorable outcome rate decreases ORY-OSY.

Dataflows T-U of validation Y occur during the first phase of favorable outcome rate decrease 133. The validation corpus contains many inputs, including 110. Only inferences from inputs having value R for sensitive feature 120 are used to measure a favorable outcome rate (not shown) for protected group R.

In this example as discussed earlier herein, a distinct value or subrange of distinct values of sensitive feature 120 identifies a distinct protected group. In other examples, sensitive feature 120 does not identify protected groups but, instead, sensitive feature 120 is correlated: a) to another sensitive feature that does identify protected groups and/or b) directly to the protected groups, which are not based on sensitive feature 120. For example as discussed later herein, (b) may occur even if the validation corpus has no sensitive feature(s), in which case feature 120 is not sensitive.

Dataflow T is biphasic, which means that a favorable outcome rate (not shown) for protected group R is measured before measuring favorable outcome rate decrease ORY by subtracting validation Y's favorable outcome rate for protected group R from validation 0's favorable outcome rate (not shown) for protected group R. Dataflow U demonstrates that favorable outcome rate decrease OSY is measured in a same way, except that the protected group is S instead of R.

If favorable outcome rate decrease ORY is non-negative (i.e. not less than zero), then protected group R is not harmed by multipliers 161-162. If favorable outcome rate decrease ORY is negative, then favorable outcome rate decrease ORY is treated as if it were rounded up to zero when using favorable outcome rate decrease ORY to measure overall favorable outcome rate decrease OY. In this example, a lower favorable outcome rate decrease 133 is better, and zero is the best. For example if overall favorable outcome rate decrease OY is zero, none of protected groups R-S are harmed by multipliers 161Y-162Y.

Fairness metrics 132-133 are different, and different tradeoffs between them and between accuracy 131 may be generated by tri-objective optimizer 170. Each of validations Y-Z has a distinct tradeoff between metrics 131-133, and there may be many validations. As discussed below, a Pareto frontier identifies a best subset of validations, and (e.g. interactive) selection of a single best validation may or may not be subjective.

Favorable outcome rate decrease 133 may compare baseline validation 0 to either of validations Y-Z. However, comparing validation 0 to itself is unnecessary because all of favorable outcome rate decreases O0 and OR0-OS0 are always zero as shown. In other words, favorable outcome rate decrease 133 is a validation metric that is not applied to validation 0.

### 1.7 Black Box Optimizer

In an embodiment, tri-objective optimizer 170 is exploratory in an evolutionary (e.g. generational) way. For example, tri-objective optimizer 170 may receive initial validation scores F0 and A0 that respectively are a fairness score and an accuracy score as shown in supervised validation scores 180. In an embodiment, tri-objective optimizer 170 is a multi-objective evolutionary algorithm (MOEA) such as a fast and elitist multi-objective genetic algorithm such as non-dominated sorting genetic algorithm II (NSGA-II) that has a python implementation that is open source.

Initial validation scores F0 and A0 are based directly on original probabilities as inferred by trained model 140 during supervised validation and not based on multipliers. Validation not based on multipliers is logically the same as validation based on identity multipliers whose values are one. In that way, every validation is associated with its own distinct plurality of multipliers, which is one multiplier for each of multiple distinct protected groups as discussed above. For example as shown, there may be two multipliers 161-162 respectively for two groups that each consists of one value R or S. Herein, a validation is defined by its distinct plurality of multipliers.

### 1.8 Optimizer Integration

In an embodiment, tri-objective optimizer 170 may receive the validation scores of a validation from computer 100. For example, computer 100 may receive the distinct plurality of multipliers of a new validation from tri-objective optimizer 170, and computer 100 may evaluate the new validation and provide the validation scores of the validation back to tri-objective optimizer 170. In that way, tri-objective optimizer 170 may greedily or randomly (or a hybrid of both) explore and optimize in a multidimensional problem space that has a distinct dimension for each distinct protected group in sensitive feature 120.

Each distinct validation (i.e. distinct plurality of multipliers) is a distinct point in that multidimensional problem space. With the addition of (e.g. three) dimensions respectively for three validation metrics 131-133, the multidimensional problem space becomes a multidimensional solution space in which each point has multiple multipliers and multiple validation scores, and tri-objective optimizer 170 explores that multidimensional solution space. 1.9 PARETO FRONTIER

In an embodiment, tri-objective optimizer 170 may retain multidimensional solution points (i.e. multipliers and validation scores) of some (e.g. best scoring) or all validations. For example, tri-objective optimizer 170 may retain some or all of validation scores 180 and may, for example, generate a sequence of validations with increasing validation scores. For example, tri-objective optimizer 170 may select and retain a Pareto frontier that contains only non-dominated multidimensional solution points that are the best validations and thus have the best multipliers. A dominated solution point is dominated by any point whose validation scores equal or exceed the scores of the dominated solution point, so long as at least one score is lower in the dominated solution point. A Pareto frontier contains at least one solution point or, without limit, more. In an embodiment, tri-objective optimizer 170 does not provide a Pareto frontier to computer 100 until every generated point is validated (i.e. scored).

### 2.0 Example Classification Calibration Process

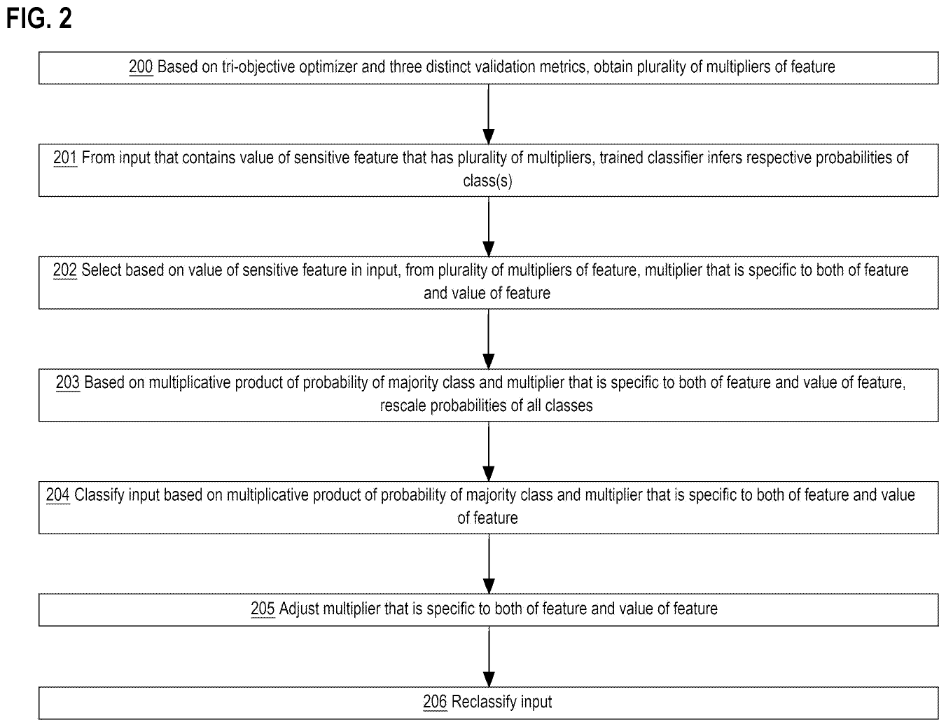

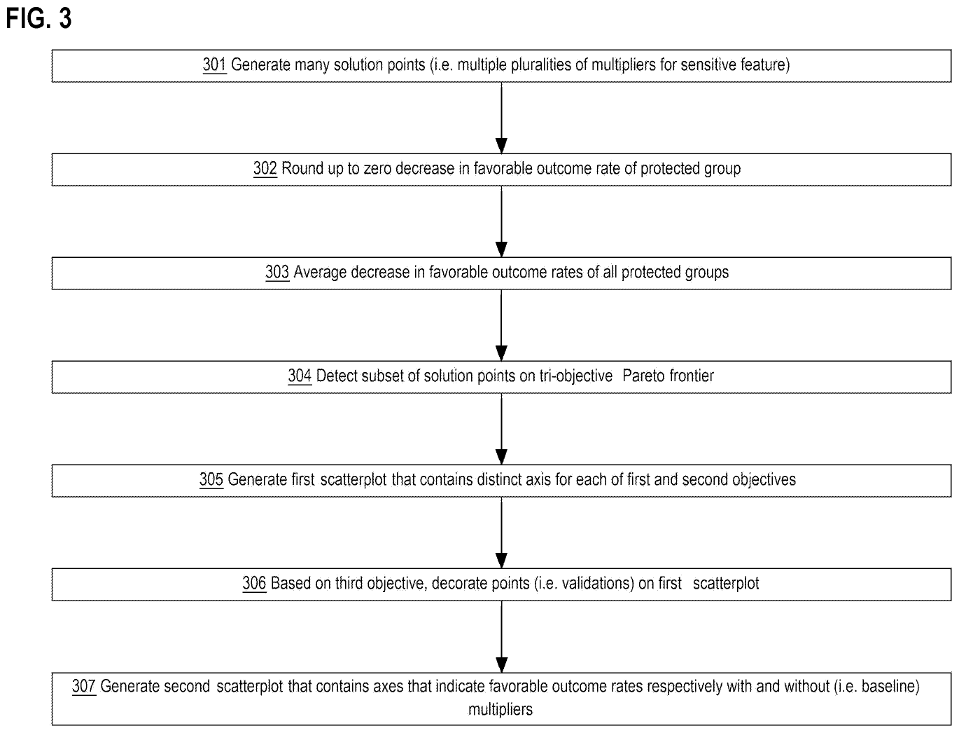

As discussed earlier herein, the lifecycle of multipliers 161-162 has an optimization phase followed by an application phase that may be performed on same or different computers in same or different environments. FIG. 2 depicts the application phase, and FIG. 3 depicts the optimization phase.

FIG. 2 is a flow diagram that depicts an example process that computer 100 may perform to classify input 110 based on postprocessing calibration of inferred probabilities PK, PL, and PM respectively for classes K-M.

Preparatory step 200 obtains predefined multipliers 161-162. For example, validation Y may have been (e.g. interactively) selected as a best validation at the end of the optimization phase as discussed later for FIG. 3. For example as discussed later herein, the optimization phase may end with an interactive phase that interactively selects validation Y as the best. That is, validation Y is preselected for step 200 to obtain multipliers 161Y-162Y instead of 161Z-162Z.

For example, computer 100 may perform the application phase more or less immediately after the optimization phase, and the process of FIG. 3 may more or less immediately precede the process of FIG. 2. In that case tri-objective optimizer 170 may, for example, directly or indirectly (e.g. interactively) provide multipliers 161Y-162Y to step 200. Thus, step 200 can be based on tri-objective optimizer 170 and its quantitative objectives 191-193 (i.e. validation metrics 131-133) and, because tri-objective optimizer 170 already generated multipliers 161Y-162Y, step 200 may obtain multipliers 161Y-162Y even if tri-objective optimizer 170 is absent (e.g. long ago discarded).

In this example, input 110 is new (i.e. was not in the validation corpus used by the optimization phase). For example, input 110 might not have existed during the optimization phase. From input 110 that contains value R of sensitive feature 120, trained classifier 140 infers probabilities PK, PL, and PM respectively for classes K-M in step 201. In a binary classification embodiment, there are only two classes K and M and trained classifier 140 infers only one probability PK for class K, which can be subtracted from one to calculate probability PM for majority class M.

Herein, there are two distinct kinds of classification, and both are supported by the approaches herein. Binary classification has only two classes from which one class is predicted. Multiclass classification instead has more than two classes from which one class is predicted. Herein, classification and prediction may be synonyms. Herein multiclass means three or more classes. Herein, two classes is not multiclass.

Recalibration herein entails postprocessing, which is some or all of the following activities and steps that occur after step 201. Based on value R of sensitive feature 120 in input 110, from multipliers 161-162 of sensitive feature 120, step 202 selects multiplier 161 that is specific to both of components 120 and R.

Between steps 202-203, computer 100 calculates a multiplicative product of probability PM of majority class M and multiplier 161. This multiplicative product is referred to herein as the multiplied majority probability or, for input 110, multiplied probability PM. That is, from input 110 are generated original probability PM and, from that, multiplied probability PM. Step 203 uses multiplied probability PM instead of original probability PM.

Based on multiplied probability PM that is based on multiplier 161, step 203 rescales probabilities 150 of all classes K-M. Rescaling by step 203 entails unit normalizing unscaled probabilities 150 that do not sum to one (because multiplied probability PM is used), which generates rescaled probabilities 150 that sum to one without changing the relative probabilities of classes K-M. For example, if unscaled probability PK is twice as big as unscaled probability PL, then rescaled probability PK still is twice as big as rescaled probability PL.

If rescaled multiplied probability PM is the highest rescaled probability in probabilities 150, then step 204 classifies input 110 as majority class M. Otherwise rescaled probability PK or PL is highest. In a multiclass (i.e. at least three classes K-M, i.e. not binary classification) embodiment, the ordering of steps 203-204 may be reversed, and classification by step 204 may compare probabilities that are unscaled instead of rescaled. Thus in some embodiments, rescaling step 203 may be optional (e.g. unimplemented). For example, normalization by rescaling step 203 may increase human interpretability.

Steps 205-206 are optional and demonstrate a scenario in which reclassification does not entail retraining classifier 140, nor revalidation, nor inferencing by trained classifier 140, nor any other use of trained classifier 140. Steps 205-206 can retroactively reclassify input 110 even if trained classifier 140 is no longer available. Step 205 adjusts one, some, or all of multipliers 161-162. As discussed earlier and later herein, tri-objective optimizer 170 generates a tri-objective Pareto frontier that may contain multiple non-dominated solution points, where each point is a distinct validation.

Whether one solution point or another is better (i.e. more optimal) depends on the application. For example, which is the best single solution point in the Pareto frontier may be a subjective determination and/or may be changed. For example, the Pareto frontier may contain non-dominated solution points G-H (not shown). Point G may be selected as best and used by earlier step 202. Step 205 may, for example, replace non-dominated point G with non-dominated point H as the revised best solution point. Based on the multipliers of replacement point H, this may or may not cause step 206 to reclassify input 110 from class K to either of classes L-M.

### 2.1 Future Proofing

Thus, classification can be recalibrated for classifying new inputs or reclassifying old inputs without retraining classifier 140, and reclassification of old inputs occurs without using trained classifier 140 at all. Recalibration effectively future proofs (i.e. avoids retraining) classifier 140 as follows. Trained classifier 140 may be needed only to infer original probabilities for new input(s). Reclassification of an old input using a different point in an old Pareto front occurs without using trained classifier 140 at all, without re-optimizing, and without using tri-objective optimizer 170.

If at least one validation objective (i.e. validation metric) is replaced, re-optimization by tri-objective optimizer 170 with an old validation corpus may generate a new Pareto front that contains new solution points. However, all of originally inferred probabilities 150-154 are reused for validation of the new solution points, which means that re-optimization with the old validation corpus does not use trained classifier 140. Even replacing tri-objective optimizer 170 with a different tri-objective optimizer and then re-optimizing with the old validation corpus does not use trained classifier 140. In those ways, trained classifier 140 is future proofed for validation metrics that do not yet exist and future proofed for tri-objective optimizers that do not yet exist.

### 3.0 Example Optimization Process

As discussed earlier herein, the lifecycle of multipliers 161-162 has an optimization phase followed by an application phase. FIG. 3 depicts the optimization phase. FIG. 3 is a flow diagram that depicts an example process that computer 100 may perform with tri-objective optimizer 170 to optimize multipliers 161-162 respectively for values R-S of sensitive feature 120.

In an embodiment, the optimization phase entails an exploration phase that entails steps 301-304 followed by an interactive phase that entails steps 305-307. Only the exploration phase uses tri-objective optimizer 170.

Baseline validation 0 and measurement of its validation scores occur before step 301. In step 301, tri-objective optimizer 170 generates many distinct solution points, each of which is a distinct validation defined by its distinct plurality of multipliers 161-162 as discussed earlier herein. Step 301 generates a sequence of validations Y-Z.

Steps 302-303 are sub-steps of step 301 that are repeated each time step 301 generates a next validation in the sequence. That is, step 301 may perform a sequence of iterations, and each iteration: a) generates a next validation that is a distinct plurality of multipliers 161-162, b) provides the distinct plurality of multipliers 161-162 to computer 100 that c) runs that validation using that distinct plurality of multipliers 161-162 and d) applies validation metrics 131-133 to measure (i.e. generate) validation scores for that validation.

Sub-steps 302-303 may occur during above (d). Sub-step 302 individually for each of protected groups R-S: a) measures a respective favorable outcome rate as discussed earlier herein, b) measures a respective positive decrease or negative (i.e. increase) decrease by comparing the current validation to baseline validation 0 as discussed earlier herein, and c) for use in next sub-step 303, rounds up to zero the decrease in the favorable outcome rate of the protected group. For example for validation Y, (c) may round up to zero both of favorable outcome rate decreases ORY-OSY. The purpose of rounding up to zero is to prevent, in next sub-step 303, a favorable outcome rate increase of, for example, protected group R from offsetting (i.e. hiding) a favorable outcome rate decrease of protected group S.

Sub-step 303 averages the rounded decreases in favorable outcome rates of all protected groups R-S. For example for validation Y, sub-step 303 measures favorable outcome rate decrease OY based on rounded favorable outcome rate decreases ORY-OSY.

In step 304, tri-objective optimizer 170 detects the subset of generated solution points (i.e. validations) that are on a tri-objective Pareto frontier and returns that subset to computer 100 as discussed earlier herein.

After the exploration phase, the interactive phase may occur. In this example, the interactive phase generates and presents two scatterplots. Both scatterplots are two dimensional.

Step 305 generates a first scatterplot that contains distinct axis for two of the three validation metrics 131-133 that correspond to respective quantitative objectives 191-193. For example: a) the horizontal axis may represent accuracy 131, b) the vertical axis may represent fairness 132, and c) favorable outcome rate decrease 133 does not correspond to either axis. In any case, both axes of the first scatterplot are independent. Each point in the first scatterplot represents a distinct validation.

In an embodiment, step 305 displays only the Pareto frontier as a curve in the first scatterplot. For example, validation Y is a point in the first scatterplot only if validation Y is part of the Pareto frontier.

Generated validations that are part of the Pareto frontier are plotted as points on the curve based on their validation scores. Thus, a user may perceive the curve as a spectrum of non-dominated three-way tradeoffs between accuracy and fairness, where the opposite poles of the spectrum respectively maximize accuracy or fairness, and all points on the curve between both poles are optimal and distinct compromises. For example, the user may interactively select (e.g. click or hover) a non-dominated solution point on the curve (i.e. the Pareto frontier) to cause computer 100 to display the details of that validation, including the distinct plurality of multipliers for sensitive feature 120 and some or all of the validation scores of that validation.

Thus, the user may interactively explore the Pareto frontier that was automatically generated by tri-objective optimizer 170 and may, for example, discover a particular non-dominated solution point that (e.g. subjectively) seems best.

In an embodiment, computer 100 automatically preselects one generated solution point on the Pareto frontier as a default best solution point. For example, computer 100 may select the generated solution point that has a highest fairness or accuracy or highest (e.g. weighted) sum of fairness and accuracy scores.

Based on the validation metric (and quantitative objective) that does not correspond to either axis, step 306 decorates the points in the first scatterplot. For example, step 306 may color points according to favorable outcome rate decrease 133 to indicate how well is quantitative objective 193 fulfilled by each point (i.e. validation).

Step 307 generates a second scatterplot that contains axes that indicate favorable outcome rates with (i.e. validation Y-Z) and without (i.e. baseline validation 0) multipliers, and both axes are independent. For example, the horizontal axis may represent the favorable outcome rate of validation 0 and the vertical axis may represent the favorable outcome rates of validations Y-Z. The second scatterplot contains a distinct point for each distinct combination of protected group and validation. For example, if there are five distinct protected groups and seven distinct validations in the Pareto frontier, then the second scatterplot contains 5×7=35 points.

Both generated scatterplots are respective global explanations for how multipliers 161-162 affect classification of the inferences of trained classifier 140. Either or both of these global explanations (i.e. scatterplots) may be generated, archived, emailed, and/or displayed.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

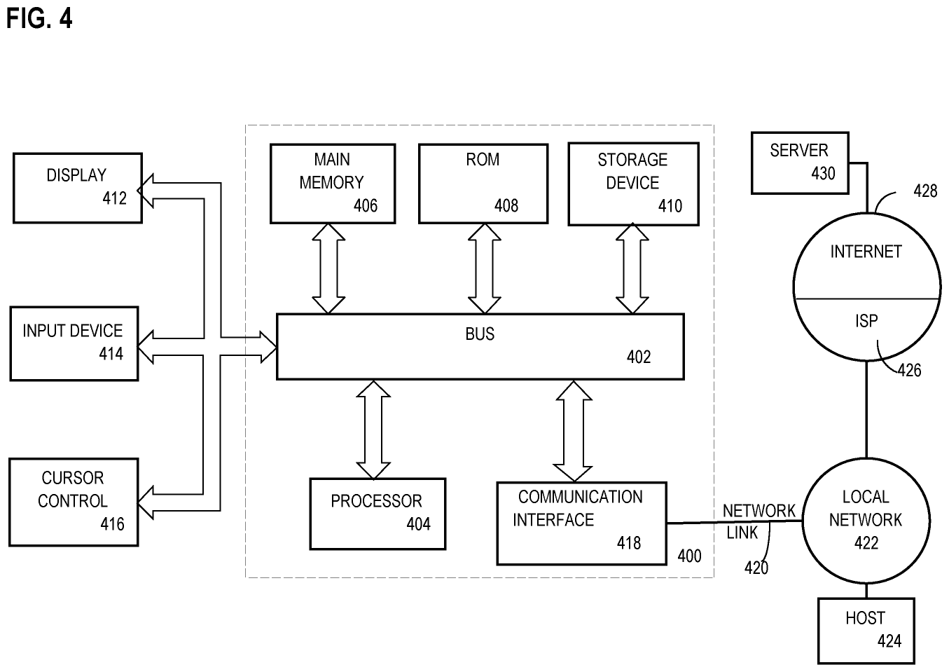

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Over View

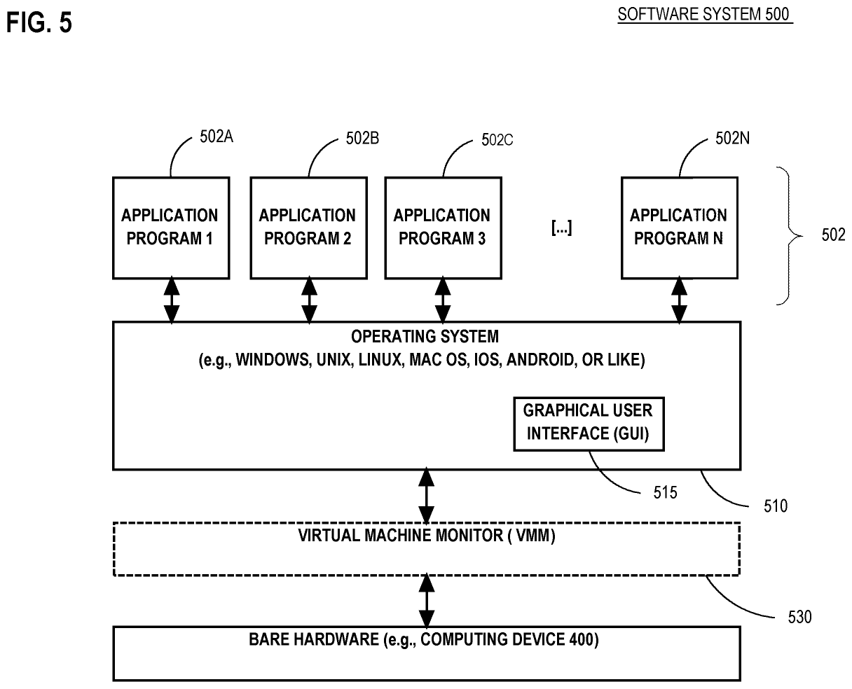

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 400 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### Machine Learning Models

A machine learning model is trained using a particular machine learning algorithm. Once trained, input is applied to the machine learning model to make a prediction, which may also be referred to herein as a predicated output or output. Attributes of the input may be referred to as features and the values of the features may be referred to herein as feature values.

A machine learning model includes a model data representation or model artifact. A model artifact comprises parameters values, which may be referred to herein as theta values, and which are applied by a machine learning algorithm to the input to generate a predicted output. Training a machine learning model entails determining the theta values of the model artifact. The structure and organization of the theta values depend on the machine learning algorithm.

In supervised training, training data is used by a supervised training algorithm to train a machine learning model. The training data includes input and a “known” output. In an embodiment, the supervised training algorithm is an iterative procedure. In each iteration, the machine learning algorithm applies the model artifact and the input to generate a predicted output. An error or variance between the predicted output and the known output is calculated using an objective function. In effect, the output of the objective function indicates the accuracy of the machine learning model based on the particular state of the model artifact in the iteration. By applying an optimization algorithm based on the objective function, the theta values of the model artifact are adjusted. An example of an optimization algorithm is gradient descent. The iterations may be repeated until a desired accuracy is achieved or some other criteria are met.

In a software implementation, when a machine learning model is referred to as receiving an input, being executed, and/or generating an output or prediction, a computer system process executing a machine learning algorithm applies the model artifact against the input to generate a predicted output. A computer system process executes a machine learning algorithm by executing software configured to cause execution of the algorithm. When a machine learning model is referred to as performing an action, a computer system process executes a machine learning algorithm by executing software configured to cause performance of the action.

Inferencing entails a computer applying the machine learning model to an input such as a feature vector to generate an inference by processing the input and content of the machine learning model in an integrated way. Inferencing is data driven according to data, such as learned coefficients, that the machine learning model contains. Herein, this is referred to as inferencing by the machine learning model that, in practice, is execution by a computer of a machine learning algorithm that processes the machine learning model.

Classes of problems that machine learning (ML) excels at include clustering, classification, regression, anomaly detection, prediction, and dimensionality reduction (i.e. simplification). Examples of machine learning algorithms include decision trees, support vector machines (SVM), Bayesian networks, stochastic algorithms such as genetic algorithms (GA), and connectionist topologies such as artificial neural networks (ANN). Implementations of machine learning may rely on matrices, symbolic models, and hierarchical and/or associative data structures. Parameterized (i.e. configurable) implementations of the best breed machine learning algorithms may be found in open source libraries such as Google's TensorFlow for Python and C++ or Georgia Institute of Technology's MLPack for C++. Shogun is an open source C++ ML library with adapters for several programing languages including C#, Ruby, Lua, Java, MatLab, R, and Python.

### Artificial Neural Networks

An artificial neural network (ANN) is a machine learning model that at a high level models a system of neurons interconnected by directed edges. An overview of neural networks is described within the context of a layered feedforward neural network. Other types of neural networks share characteristics of neural networks described below.

In a layered feed forward network, such as a multilayer perceptron (MLP), each layer comprises a group of neurons. A layered neural network comprises an input layer, an output layer, and one or more intermediate layers referred to hidden layers.

Neurons in the input layer and output layer are referred to as input neurons and output neurons, respectively. A neuron in a hidden layer or output layer may be referred to herein as an activation neuron. An activation neuron is associated with an activation function. The input layer does not contain any activation neurons.

From each neuron in the input layer and a hidden layer, there may be one or more directed edges to an activation neuron in the subsequent hidden layer or output layer. Each edge is associated with a weight. An edge from a neuron to an activation neuron represents input from the neuron to the activation neuron, as adjusted by the weight.

For a given input to a neural network, each neuron in the neural network has an activation value. For an input neuron, the activation value is simply an input value for the input. For an activation neuron, the activation value is the output of the respective activation function of the activation neuron.

Each edge from a particular neuron to an activation neuron represents that the activation value of the particular neuron is an input to the activation neuron, that is, an input to the activation function of the activation neuron, as adjusted by the weight of the edge. Thus, an activation neuron in the subsequent layer represents that the particular neuron's activation value is an input to the activation neuron's activation function, as adjusted by the weight of the edge. An activation neuron can have multiple edges directed to the activation neuron, each edge representing that the activation value from the originating neuron, as adjusted by the weight of the edge, is an input to the activation function of the activation neuron.

Each activation neuron is associated with a bias. To generate the activation value of an activation neuron, the activation function of the neuron is applied to the weighted activation values and the bias.

### Illustrative Data Structures for Neural Network

The artifact of a neural network may comprise matrices of weights and biases. Training a neural network may iteratively adjust the matrices of weights and biases.

For a layered feedforward network, as well as other types of neural networks, the artifact may comprise one or more matrices of edges W. A matrix W represents edges from a layer L−1 to a layer L. Given the number of neurons in layer L−1 and L is N[L−1] and N[L], respectively, the dimensions of matrix W is N[L−1] columns and N[L] rows.

Biases for a particular layer L may also be stored in matrix B having one column with N[L] rows.

The matrices W and B may be stored as a vector or an array in RAM memory, or comma separated set of values in memory. When an artifact is persisted in persistent storage, the matrices W and B may be stored as comma separated values, in compressed and/serialized form, or other suitable persistent form.

A particular input applied to a neural network comprises a value for each input neuron. The particular input may be stored as a vector. Training data comprises multiple inputs, each being referred to as a sample in a set of samples. Each sample includes a value for each input neuron. A sample may be stored as a vector of input values, while multiple samples may be stored as a matrix, each row in the matrix being a sample.

When an input is applied to a neural network, activation values are generated for the hidden layers and output layer. For each layer, the activation values for may be stored in one column of a matrix A having a row for every neuron in the layer. In a vectorized approach for training, activation values may be stored in a matrix, having a column for every sample in the training data.

Training a neural network requires storing and processing additional matrices. Optimization algorithms generate matrices of derivative values which are used to adjust matrices of weights W and biases B. Generating derivative values may use and require storing matrices of intermediate values generated when computing activation values for each layer.

The number of neurons and/or edges determines the size of matrices needed to implement a neural network. The smaller the number of neurons and edges in a neural network, the smaller matrices and amount of memory needed to store matrices. In addition, a smaller number of neurons and edges reduces the amount of computation needed to apply or train a neural network. Fewer neurons means fewer activation values need be computed, and/or fewer derivative values need be computed during training.

Properties of matrices used to implement a neural network correspond to neurons and edges. A cell in a matrix W represents a particular edge from a neuron in layer L−1 to L. An activation neuron represents an activation function for the layer that includes the activation function. An activation neuron in layer L corresponds to a row of weights in a matrix W for the edges between layer L and L−1 and a column of weights in a matrix W for edges between layer L and L+1. During execution of a neural network, a neuron also corresponds to one or more activation values stored in matrix A for the layer and generated by an activation function.

An ANN is amenable to vectorization for data parallelism, which may exploit vector hardware such as single instruction multiple data (SIMD), such as with a graphical processing unit (GPU). Matrix partitioning may achieve horizontal scaling such as with symmetric multiprocessing (SMP) such as with a multicore central processing unit (CPU) and or multiple coprocessors such as GPUs. Feed forward computation within an ANN may occur with one step per neural layer. Activation values in one layer are calculated based on weighted propagations of activation values of the previous layer, such that values are calculated for each subsequent layer in sequence, such as with respective iterations of a for loop. Layering imposes sequencing of calculations that are not parallelizable. Thus, network depth (i.e. amount of layers) may cause computational latency. Deep learning entails endowing a multilayer perceptron (MLP) with many layers. Each layer achieves data abstraction, with complicated (i.e. multidimensional as with several inputs) abstractions needing multiple layers that achieve cascaded processing. Reusable matrix-based implementations of an ANN and matrix operations for feed forward processing are readily available and parallelizable in neural network libraries such as Google's TensorFlow for Python and C++, OpenNN for C++, and University of Copenhagen's fast artificial neural network (FANN). These libraries also provide model training algorithms such as backpropagation.

### Backpropagation

An ANN's output may be more or less correct. For example, an ANN that recognizes letters may mistake an I as an L because those letters have similar features. Correct output may have particular value(s), while actual output may have somewhat different values. The arithmetic or geometric difference between correct and actual outputs may be measured as error according to a loss function, such that zero represents error free (i.e. completely accurate) behavior. For any edge in any layer, the difference between correct and actual outputs is a delta value.

Backpropagation entails distributing the error backward through the layers of the ANN in varying amounts to all of the connection edges within the ANN. Propagation of error causes adjustments to edge weights, which depend on the gradient of the error at each edge. Gradient of an edge is calculated by multiplying the edge's error delta times the activation value of the upstream neuron. When the gradient is negative, the greater the magnitude of error contributed to the network by an edge, the more the edge's weight should be reduced, which is negative reinforcement. When the gradient is positive, then positive reinforcement entails increasing the weight of an edge whose activation reduced the error. An edge weight is adjusted according to a percentage of the edge's gradient. The steeper is the gradient, the bigger is adjustment. Not all edge weights are adjusted by a same amount. As model training continues with additional input samples, the error of the ANN should decline. Training may cease when the error stabilizes (i.e. ceases to reduce) or vanishes beneath a threshold (i.e. approaches zero). Example mathematical formulae and techniques for feedforward multilayer perceptron (MLP), including matrix operations and backpropagation, are taught in related reference “EXACT CALCULATION OF THE HESSIAN MATRIX FOR THE MULTI-LAYER PERCEPTRON,” by Christopher M. Bishop.

Model training may be supervised or unsupervised. For supervised training, the desired (i.e. correct) output is already known for each example in a training set. The training set is configured in advance by (e.g. a human expert) assigning a categorization label to each example. For example, the training set for optical character recognition may have blurry photographs of individual letters, and an expert may label each photo in advance according to which letter is shown. Error calculation and backpropagation occur as explained above.

### Autoencoder

Unsupervised model training is more involved because desired outputs need to be discovered during training. Unsupervised training may be easier to adopt because a human expert is not needed to label training examples in advance. Thus, unsupervised training saves human labor. A natural way to achieve unsupervised training is with an autoencoder, which is a kind of ANN. An autoencoder functions as an encoder/decoder (codec) that has two sets of layers. The first set of layers encodes an input example into a condensed code that needs to be learned during model training. The second set of layers decodes the condensed code to regenerate the original input example. Both sets of layers are trained together as one combined ANN. Error is defined as the difference between the original input and the regenerated input as decoded. After sufficient training, the decoder outputs more or less exactly whatever is the original input.

An autoencoder relies on the condensed code as an intermediate format for each input example. It may be counter-intuitive that the intermediate condensed codes do not initially exist and instead emerge only through model training. Unsupervised training may achieve a vocabulary of intermediate encodings based on features and distinctions of unexpected relevance. For example, which examples and which labels are used during supervised training may depend on somewhat unscientific (e.g. anecdotal) or otherwise incomplete understanding of a problem space by a human expert. Whereas unsupervised training discovers an apt intermediate vocabulary based more or less entirely on statistical tendencies that reliably converge upon optimality with sufficient training due to the internal feedback by regenerated decodings. Techniques for unsupervised training of an autoencoder for anomaly detection based on reconstruction error is taught in non-patent literature (NPL) “VARIATIONAL AUTOENCODER BASED ANOMALY DETECTION USING RECONSTRUCTION PROBABILITY”, Special Lecture on IE. 2015 Dec. 27; 2(1):1-18 by Jinwon An et al.

### Principal Component Analysis

Principal component analysis (PCA) provides dimensionality reduction by leveraging and organizing mathematical correlation techniques such as normalization, covariance, eigenvectors, and eigenvalues. PCA incorporates aspects of feature selection by eliminating redundant features. PCA can be used for prediction. PCA can be used in conjunction with other ML algorithms.

### Random Forest

A random forest or random decision forest is an ensemble of learning approaches that construct a collection of randomly generated nodes and decision trees during a training phase. Different decision trees of a forest are constructed to be each randomly restricted to only particular subsets of feature dimensions of the data set, such as with feature bootstrap aggregating (bagging). Therefore, the decision trees gain accuracy as the decision trees grow without being forced to over fit training data as would happen if the decision trees were forced to learn all feature dimensions of the data set. A prediction may be calculated based on a mean (or other integration such as soft max) of the predictions from the different decision trees.

Random forest hyper-parameters may include: number-of-trees-in-the-forest, maximum-number-of-features-considered-for-splitting-a-node, number-of-levels-in-each-decision-tree, minimum-number-of-data-points-on-a-leaf-node, method-for-sampling-data-points, etc.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
obtaining, from a tri-objective optimizer that has three distinct validation metrics to respectively optimize three distinct validation metrics, a plurality of multipliers of a feature;
inferring, from an input that contains a value of the feature, a probability of a class;
selecting based on the value of the feature in the input, from the plurality of multipliers of the feature, a multiplier that is specific to both of the feature and the value of the feature; and
classifying the input based on a multiplicative product of the probability of the class and the multiplier that is specific to both of the feature and the value of the feature;
wherein the method is performed by one or more computers.

2. The method of claim 1 wherein the three distinct validation metrics comprise a fitness metric and a fairness metric.

3. The method of claim 1 wherein the three distinct validation metrics comprise two fairness metrics.

4. The method of claim 1 wherein:
the three distinct validation metrics comprise a decrease in a favorable outcome rate;
the tri-objective optimizer has an objective that minimizes the decrease in the favorable outcome rate.

5. The method of claim 4 wherein the decrease in the favorable outcome rate is an average decrease in favorable outcome rates of a plurality of protected groups.

6. The method of claim 5 further comprising rounding up to zero a decrease in a favorable outcome rate of a particular protected group of the plurality of protected groups.

7. The method of claim 1 further comprising:
generating multiple pluralities of multipliers of the feature;
detecting a subset of the multiple pluralities of multipliers of the feature that are on a tri-objective Pareto frontier.

8. The method of claim 7 wherein:
the three distinct validation metrics comprise a first validation metric, a second validation metric, and a third validation metric;
the method further comprises generating a scatterplot that contains:
the subset of the multiple pluralities of multipliers of the feature that are on the tri-objective Pareto frontier, and
a distinct axis for each of the first validation metric and the second validation metric;
visually decorating, based on the third validation metric, the subset of the multiple pluralities of multipliers of the feature.

9. The method of claim 8 wherein the third validation metric is a decrease in a favorable outcome rate.

10. The method of claim 1 wherein:
said classifying the input is a first classifying;
the method further comprises:
second classifying the input without using the plurality of multipliers of the feature;
generating a scatterplot that contains:
a) a first axis that indicates a favorable outcome rate based on the first classifying,
b) a second axis that indicates a favorable outcome rate based on the second classifying, and
c) for each protected group of a plurality of protected groups, a respective point for each plurality of multipliers of multiple pluralities of multipliers of the feature.

11. One or more computer-readable non-transitory media storing instructions that, when executed by one or more processors, cause:
obtaining, from a tri-objective optimizer that has three distinct validation metrics to respectively optimize three distinct validation metrics, a plurality of multipliers of a feature;
inferring, from an input that contains a value of the feature, a probability of a class;
selecting based on the value of the feature in the input, from the plurality of multipliers of the feature, a multiplier that is specific to both of the feature and the value of the feature; and
classifying the input based on a multiplicative product of the probability of the class and the multiplier that is specific to both of the feature and the value of the feature.

12. The one or more computer-readable non-transitory media of claim 11 wherein the three distinct validation metrics comprise a fitness metric and a fairness metric.

13. The one or more computer-readable non-transitory media of claim 11 wherein the three distinct validation metrics comprise two fairness metrics.

14. The one or more computer-readable non-transitory media of claim 11 wherein:
the three distinct validation metrics comprise a decrease in a favorable outcome rate;
the tri-objective optimizer has an objective that minimizes the decrease in the favorable outcome rate.

15. The one or more computer-readable non-transitory media of claim 14 wherein the decrease in the favorable outcome rate is an average decrease in favorable outcome rates of a plurality of protected groups.

16. The one or more computer-readable non-transitory media of claim 15 wherein the instructions further cause rounding up to zero a decrease in a favorable outcome rate of a particular protected group of the plurality of protected groups.

17. The one or more computer-readable non-transitory media of claim 11 wherein the instructions further cause:
generating multiple pluralities of multipliers of the feature;
detecting a subset of the multiple pluralities of multipliers of the feature that are on a tri-objective Pareto frontier.

18. The one or more computer-readable non-transitory media of claim 17 wherein:
the three distinct validation metrics comprise a first validation metric, a second validation metric, and a third validation metric;
the instructions further cause generating a scatterplot that contains:
the subset of the multiple pluralities of multipliers of the feature that are on the tri-objective Pareto frontier, and
a distinct axis for each of the first validation metric and the second validation metric;
visually decorating, based on the third validation metric, the subset of the multiple pluralities of multipliers of the feature.

19. The one or more computer-readable non-transitory media of claim 18 wherein the third validation metric is a decrease in a favorable outcome rate.

20. The one or more computer-readable non-transitory media of claim 11 wherein:
said classifying the input is a first classifying;
the instructions further cause:
second classifying the input without using the plurality of multipliers of the feature;
generating a scatterplot that contains:
a) a first axis that indicates a favorable outcome rate based on the first classifying,
b) a second axis that indicates a favorable outcome rate based on the second classifying, and
c) for each protected group of a plurality of protected groups, a respective point for each plurality of multipliers of multiple pluralities of multipliers of the feature.
